(19) United States
(12) Patent Application Publication
(10) Pub. No.: US 2020/0263981 A1
(43) Pub. Date: Aug. 20, 2020

(54) Effect of Fuel Doping in ICF Targets

(71) Applicants: Robert O. Hunter, JR., Aspen, CO (US); Eric W. Cornell, Colorado Springs, CO (US)

(72) Inventors: Robert O. Hunter, JR., Aspen, CO (US); Eric W. Cornell, Colorado Springs, CO (US)

(73) Assignee: Innoven Energy LLC, Colorado Springs, CO (US)

(21) Appl. No.: 16/796,084

(22) Filed: Feb. 20, 2020

Related U.S. Application Data
(60) Provisional application No. 62/808,070, filed on Feb. 20, 2019.

(51) Int. Cl. G01B 11/28; G21B 1/19; G01B 11/255

(52) U.S. Cl. CPC G01B 11/28; G01B 11/06; G01B 11/255; G21B 1/19

(57) ABSTRACT

In Inertial Confinement Fusion (ICF) targets that ignite a fuel section having a low areal density at ignition, the fuel section tends to have a very non-uniform temperature profile. As the areal density decreases, the temperature profile becomes less uniform. This leads to non-equilibrium ignition and a non-uniform density profile. However, there is an optimal material and content for the fuel region for any given target design. One can smooth both the temperature and density profiles in the fuel of non-equilibrium ignition targets while still allowing runaway burn but preventing margin parameters such as fall-line from being affected greatly.

### CROSS-REFERENCE TO RELATED APPLICATIONS

This application claims the benefit of U.S. Provisional Application No. 62/808,070 filed on Feb. 20, 2019, which is incorporated herein by reference.

### BACKGROUND

Nuclear fusion by inertial confinement (Inertial Confinement Fusion, or “ICF”) utilizes nuclear fusion reactions to produce energy. In most types of ICF system, an external drive mechanism such as a laser delivers energy to a target containing nuclear fusion fuel. The target is designed to use this energy to compress, heat and ignite the fusion fuel within it. If a sufficient amount of fuel is compressed sufficiently and heated sufficiently, a self-sustaining fusion reaction can occur, in which energy produced by fusion reactions continues to heat the fuel (“ignition”). The inertia of the compressed fuel can keep it from expanding long enough for significant energy to be produced, before expansion of the fuel and the resultant cooling terminates the fusion reaction. Most conventional ICF target designs involve a spherical target which is imploded symmetrically from all directions, relying on stagnation of inwardly-accelerated fuel at the center of the sphere to produce the required densities and temperatures.

Production of the very high temperatures and densities required for fusion ignition may require a substantial amount of energy. The exact amount of energy required depends on the specific target design in use. In order to be useful for energy generation, the target must be capable of producing more energy from fusion reactions than was required to ignite it. In addition, the amount of energy required by the target must be physically and/or economically realizable by the drive mechanism being used.

For this reason, conventional ICF target designs have focused on achieving the required temperatures and densities as efficiently as possible. These designs are often complex in their construction and operation, and sensitive to imperfection in the target's manufacturing and to non-uniformity in the delivery of energy to the target from the drive mechanism. Imperfection and non-uniformity can lead to asymmetry in the target's implosion, which may reduce the densities and temperatures achieved, potentially below the threshold required for ignition. Furthermore, successful operation of these complex designs often requires achieving a precise balance between multiple competing physical processes, many of which are poorly understood and difficult to model. When actually constructed and deployed, these complex ICF target designs often fail to perform as their designers intended, and to date none have actually succeeded in producing ignition.

The NIF target exemplifies the conventional approach. The NIF target, as described in Haan, Physics of Plasmas 18, 051001 (2011), involves an outer ablator shell comprising primarily plastic or beryllium with various dopants, surrounding a shell of cryogenic DT ice, with a central void filled with low-density DT gas. The target is placed in a cylindrical hohlraum. The entire target assembly (hohlraum and target) is then placed in the target chamber where a laser consisting of 192 separate beamlines, with a total energy delivered to the hohlraum of up to 1.8 MJ, illuminates a number of spots on the inner surface of the hohlraum, producing a radiation field which fills the hohlraum. The radiation field ablates the ablator layer, and the reactive force of the ablator ablating implodes the target. The laser pulse is 18 nanoseconds long and is temporally tailored in order to drive a series of precisely-adjusted shocks into the target. The timing and energy level of these shocks are adjusted in order to achieve a quasi-isentropic, efficient implosion and compression of the shell of DT fuel. Stagnation of these shocks and inward-moving material at the center of the target is intended to result in the formation of a small “hotspot” of fuel, at a temperature of roughly 10 keV and a pr of approximately 0.3 g/cm², surrounded by a much larger mass of relatively cold DT fuel, and it is intended that the fuel in the “hotspot” will ignite, with fusion burn then propagating into the cold outer shell.

In practice, the NIF target has so far failed to ignite, achieving peak temperatures and densities of about 3 keV and a pr of approximately 0.1 g/cm² in the hotspot, short of the 10 keV and 0.3 g/cm² anticipated to be required for ignition. There is no clear consensus on what has caused the failure of the NIF target to achieve ignition, but it appears that this failure may be partially due to low-order asymmetry in the hotspot formation and lower than expected implosion velocities.

An ICF target design and implosion mechanism which is more robust against non-uniformities, simpler to analyze and simpler to utilize would be advantageous in achieving practical energy generation through ICF.

### SUMMARY

In ICF targets that ignite a DT fuel section having ρr<1 g/cm² at ignition, the fuel section tends to have a very non-uniform temperature profile which leads to non-equilibrium ignition and a non-uniform density profile. However, there is an optimal material and content for the fuel region for any given target design. One can smooth both the temperature and density profiles in the fuel of non-equilibrium ignition targets while still allowing runaway burn but preventing margin parameters such as fall-line from being affected greatly.

### DRAWINGS

FIG. 1 shows a single shell configuration of an ICF target.

FIG. 2 shows a double shell configuration of an ICF target.

FIG. 3 plots the temperature profile of the fuel region.

FIG. 4 plots the fall line parameter.

FIG. 5 plots the temperature profile of the varying degrees of Iron mixed into the fuel region.

FIG. 6 plots the Iron content in the fuel region versus the yield.

### DETAILED DESCRIPTION

Nuclear fusion may refer to a type of reaction that occurs when certain atomic nuclei collide. In most of these reactions, two light nuclei combine, producing heavier nuclei and/or nuclear particles. In the process, some of the energy in the nuclear bonds holding the nuclei together is released, usually settling in the form of thermal energy (heat) in the material surrounding the reacting particles. These reactions only occur between atomic nuclei that are very energetic, such as those that have been heated to a high temperature to form a plasma. The specific temperatures vary between reactions. The reaction between deuterium and tritium, two hydrogen isotopes, is generally considered to require the lowest temperature for ignition. As other fusion reactions require higher temperatures, most nuclear fusion power concepts envision the use of D-T fuel.

Two challenges in using nuclear fusion to produce power are referred to as ignition and confinement. Achieving ignition requires heating a plasma of fusion fuel until it becomes hot enough to heat itself, meaning the energy released from fusion reactions exceeds the energy lost through various processes, such as Bremsstrahlung radiation and hydrodynamic expansion. The temperature at which this occurs is known as the “ignition temperature,” which for D-T fuel can range from 2-10 keV, depending on the physical properties of the plasma. After ignition, self-heating in the fuel can cause it to reach temperatures of 100 keV or more.

Once fuel has been ignited, confinement may refer to the challenge of keeping the fuel from expanding (thus cooling and ceasing to burn) long enough for it to produce the desired amount of energy: at least as much energy as was required to ignite the fuel and keep it confined—and hopefully significantly more. While heating the fuel to ignition is simply a matter of delivering energy to it, confinement is more challenging. There is no known way to confine a plasma heated to ignition temperature or beyond with a simple mechanical system. Any solid substance, such as the metal wall of a container, that comes into contact with a fusion plasma would either become instantly vaporized, would drastically cool the plasma and stop the burn itself, or both.

The method of confinement uses a magnetic field to keep the fuel from expanding. This is referred to as Magnetic Confinement Fusion (MCF). Magnetic confinement has many inherent difficulties and disadvantages, and economical power generation from an MCF facility appears decades away.

Another approach takes advantage of how the characteristics of fusion burn change with fuel amount and density. At ordinary densities and practicable amounts, a D-T plasma heated to ignition temperature will disassemble (expand and stop burning) before producing anywhere near the energy required to originally heat it. However, as the density of a given amount of fuel is increased, the rate at which the fuel will burn increases faster than the rate at which it will expand. This means that, if the fuel can be compressed sufficiently before heating it, the fuel's own resistance to motion (inertia) will keep it from expanding long enough to yield a significant amount of energy. This approach is referred to as Inertial Confinement Fusion (ICF).

Inertial Confinement Fusion reactor chambers can be designed to contain an ICF target being imploded and capture the resulting energy output from the reaction in the forms of neutrons, radiation, and/or debris. Such chambers can generally include a combination of neutron moderating layers, neutron absorbing layers, neutron shielding layers, radiation capturing layers, sacrificial layers, shock absorbers, tritium breeding layers, tritium breeders, coolant systems, injection nozzles, inert gas injection nozzles, sputterers, sacrificial coating injection nozzles, beam channels, target supporting mechanism, and/or purge ports, among others. Generally speaking, neutron moderating material can be constructed from graphite and may be naturally or artificially doped, combined, allowed, and/or mixed with neutron absorbing material and/or have a thickness of one or more neutron mean free path lengths (e.g., 0.3-1.0 m). Neutron absorbing material may include boron, cadmium, lithium, etc. Radiation tiles or layers can be disposed throughout the chamber to absorb radiation from the reaction.

The term “isentropic drive mechanism” may refer to a drive mechanism that is designed or utilized to compress material (such as fusion fuel) in an isentropic manner. “Isentropic” means compressing material while minimizing the total entropy increase (heating) of the material. Isentropic compression is therefore the most efficient way to compress material. When imploding a sphere or shell of material, such as an ICF target, isentropic compression requires that the drive mechanism deliver pressure to the material in a specific way over the entire duration of the compression, utilizing a low pressure initially that is increased over the course of the compression according to a mathematical formula. This can be difficult to achieve, and complicates the design of both the target drive mechanism and the driver that delivers energy to the drive mechanism (such as a laser or heavy ion beam).

The term “quasi-isentropic drive mechanism” may refer to a drive mechanism that approximates an ideal, perfectly-isentropic compression using a means other than a ramped pressure profile. For instance, drive mechanisms that compress material by producing a series of shocks of increasing strength may approach the efficiency of a perfectly-isentropic compression. While in some circumstances that are simpler than perfectly isentropic versions, these drive mechanisms are still complex to engineer.

The term “impulsive drive mechanism” may refer to a drive mechanism that compresses material impulsively, typically by the production of a single shock wave that accelerates the material and causes it to move inward. The pressure produced by an impulsive drive mechanism is typically highest at the beginning of the implosion, and decreases afterward. Impulsive drive mechanisms are limited in the amount of compression they can produce and in the efficiency of compression achieved. They may be simpler to design and use than other drive mechanisms. For instance, an impulsive drive mechanism may not require that the driver (laser, heavy ion beam, etc.) be active during the entire course of the implosion, but may instead deliver its energy over a shorter timescale, potentially short comparable to the timescale of hydrodynamic motion in the target.

The term “shock” may refer to sharp discontinuities in the flow of material. These discontinuities can be induced in any hydrodynamic variables such as temperature, pressure, density, velocity, etc.

The term “shock convergence” may refer to the convergence of a shock which may travel from an outer shell and to an inner shell. It is calculated as the ratio of the outer radius of an inner shell, R_{c}, and the inner radius of an outer shell Rₒ. That is,

$$SC = \frac{{R}_{o}}{{R}_{C}}$$

For instance, given a first shell with an inner radius of 10 cm, and a second shell disposed within the first shell with an inner radius of 0.5 cm, the shock convergence is 20. Any other combination of inner and outer radiuses can be used.

The term “atom” may refer to a particle of matter, composed of a nucleus of tightly-bound protons and neutrons with an electron shell. Each element has a specific number of protons.

The term “neutron” may refer to a subatomic particle with no electrical charge. Their lack of a charge means that free neutrons generally have a greater free range in matter than other particles.

The term “proton” may refer to a subatomic particle with a positive electrical charge.

The term “electron” may refer to a subatomic particle with a negative electrical charge, exactly opposite to that of a proton and having less mass than a proton and a neutron. Atoms under ordinary conditions have the same number of electrons as protons, so that their charges cancel.

The term “isotope” may refer to atoms of the same element that have the same number of protons, but a different number of neutrons. Isotopes of an element are generally identical chemically, but may have different probabilities of undergoing nuclear reactions. The term “ion” may refer to a charged particle, such as a proton or a free nucleus.

The term “plasma” may refer to the so-called fourth state of matter, beyond solid, liquid, and gas. Matter is typically in a plasma state when the material has been heated enough to separate electrons from their atomic nuclei.

The term “Bremsstrahlung radiation” may refer to radiation produced by interactions between electrons and ions in a plasma. One of the many processes that can cool a plasma is energy loss due to Bremsstrahlung radiation.

The product “ρr” may refer to the areal mass density of a material. This term may refer to a parameter that can be used to characterize fusion burn. This product is expressed in grams per centimeter squared, unless otherwise specified.

1 The term “runaway burn” may refer to a fusion reaction that heats itself and reaches a very high temperature. Because the D-T reaction rate increases with temperature, peaking at 67 keV, a D-T plasma heated to ignition temperature may rapidly self-heat and reach extremely high temperatures, approximately 100 keV, or higher.

The term “burn fraction” may refer to the percentage of fusion fuel consumed during a given reaction. The greater the burn fraction, the higher the energy output.

The term “convergence” may refer to how much a shell (or material) has been compressed radially during implosion. For instance, a shell that starts with a radius of 0.1 cm (Rᵢ) and is compressed to a radius of 0.01 cm (R_{c}) during implosion, thus having a convergence (C) of 10. That is,

$$C = \frac{{R}_{i}}{{R}_{c}}$$

The term “approximately” includes a given value plus/minus 15%. For example, the phrase “approximately 10 units” is intended to encompass a range of 8.5 units to 11.5 units.

The term “Z” refers to the atomic number of an element, i.e. the number of protons in the nucleus. The term “A” refers to the atomic mass number of an element, i.e. the number of protons and neutrons in the nucleus.

At the pressures and temperatures involved in imploding and burning ICF targets, specific material properties that one observes in everyday life (hardness, strength, room temperature thermal conductivity, etc.) may be irrelevant, and the hydrodynamic behavior of a material can depend most strongly on the material's average atomic number, atomic mass number, and solid density. As such, in discussing material requirements in ICF targets, it is convenient to discuss classes of material. For the purposes of the following discussion, the term “low-Z” will refer to materials with an atomic number of 1-5 (hydrogen to boron); the term “medium-Z” will refer to materials with an atomic number of 6-47 (carbon to silver); and the term “high-Z” will refer to materials with an atomic number greater than 48 (cadmium and above). Unless otherwise stated, the use of these terms to describe a class of material for a specific function is intended only to suggest that this class of material may be particularly advantageous for that function, and not (for instance) that a “high-Z” material could not be substituted where a “medium-Z” material is suggested, or vice-versa.

Specific material choice is still important, where indicated, as different isotopes of the same element undergo completely different nuclear reactions, and different elements may have different radiation opacities for specific frequencies. The differing solid densities of materials with similar Z is also important for certain design criteria.

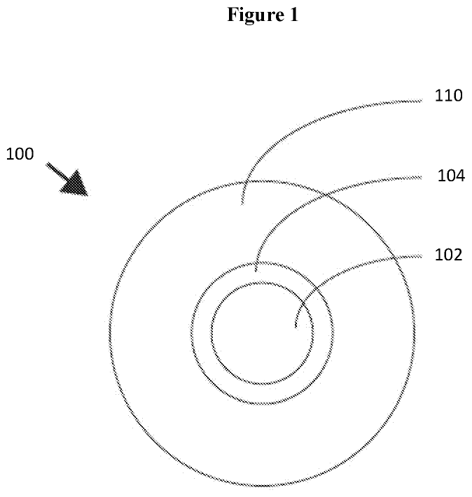

FIG. 1 shows a single shell configuration (not to scale) of an ICF target 100. ICF target 100 comprises high-Z shell 104 and fuel region 102. Fuel region may be filled with a fusion fuel mixture such as equimolar deuterium and tritium (DT). In some embodiments, fuel region 102 may have a higher ratio of deuterium to tritium, or conversely, a higher ratio of tritium to deuterium. Fuel region 102 could be filled with other types of fusion fuel such as: pure deuterium, lithium deuteride, lithium tritide, or any other fusion fuel or combination of fuels. Surrounding shell 104 is drive region/ablator region 110. ICF Target 100 may (or may not) then be placed within a hohlraum (not shown). It should be noted that any one of a variety of shapes may be selected for hohlraum (not shown), including but not limited to the following: cylindrical, spherical, or rugby-shaped. If placed in a hohlraum (not shown), laser energy may be converted to x-ray radiation in the hohlraum which may then drive/ablate the drive region/ablator region 110 to implode shell 104. Or ICF target 100 may be directly driven by laser energy, or other ways known in the art, and then drive region/ablator region 110 may implode shell 104. This inward motion of shell 104 may launch a shock into fuel region 102 which may sufficiently heat fuel region 102, and simultaneously, shell 104 may compress fuel region 102 causing it to ignite and burn a significant fraction of the fuel.

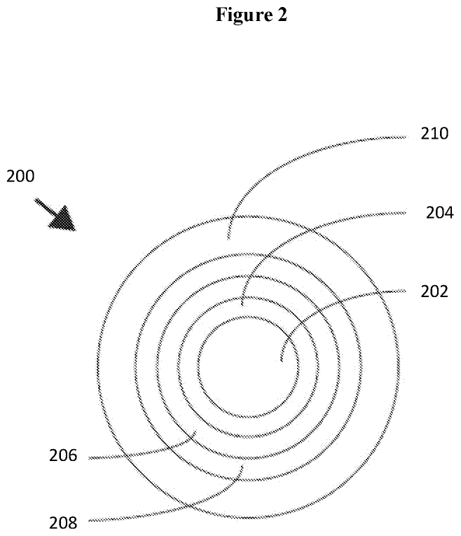

FIG. 2 depicts a double shell configuration (not to scale). ICF Target 200 comprises central spherical fuel region, the inner fuel region 202. Surrounding inner fuel region 202 is inner shell 204 and outer shell 208. In the space between inner shell 204 and outer shell 208 is outer fuel region 206. Inner fuel region 202 and outer fuel region 206 may be filled with equimolar deuterium and tritium (DT). In some embodiments, inner fuel region 202 and/or outer fuel region 206 may have a higher ratio of deuterium to tritium, or conversely, a higher ratio of tritium to deuterium. Fuel regions 202 and 206 may be filled with other types of fusion fuel, such as: pure deuterium, lithium deuteride, lithium tritide, or any other fusion fuel or combination of fuels. Some of these materials may be inert, but we will nonetheless still refer to this region as “outer fuel region” 206. Surrounding outer shell 208 is drive region/ablator region 210. ICF Target 200 may (or may not) then be placed within a hohlraum (not shown). It should be noted that any one of a variety of shapes may be selected for hohlraum (not shown), including but not limited to the following: cylindrical, spherical, or rugby-shaped. If placed in a hohlraum (not shown), laser energy may be converted to x-ray radiation in the hohlraum which may then drive/ablate drive region/ablator region 210 to implode outer shell 208. Or ICF target 200 may be directly driven by laser energy, or other ways known in the art, and then drive region/ablator region 210 may implode outer shell 208. However, whether or not ICF target 200 is placed in a hohlraum (not shown), this inward motion of outer shell 208 may launch a shock into outer fuel region 206 which may launch a shock into inner shell 204 and subsequently inner fuel region 204. This in turn may sufficiently heat outer fuel region 206, inner fuel region 202, and simultaneously, outer shell 208 may compress outer fuel region 206. Subsequently inner shell 204 may compress inner fuel region 202 and cause it to ignite and burn a significant fraction of the fuel.

For simplicity we will refer to FIG. 1, however this is also applicable to FIG. 2 where drive region/ablator region 210 is driven similar to drive region/ablator region 110 of FIG. 1. Shell 104 may implode and this inward motion of shell 104 may launch a shock into fuel region 102 which may sufficiently heat fuel. Simultaneously, shell 104 may compress fuel region 102 and cause it to ignite and burn a significant fraction of the fuel. Initially the ion and electron temperatures will stay in equilibrium. However, once the burning of the fuel reaches a certain point, the ion temperature will separate from the electron temperature. The point at which the ion temperature greatly exceeds the electron temperature is generally when the fuel enters runaway burn and energy is added to the fuel solely from fusion reactions and not PdV work being done by the shell.

Depending on the type of material (high-Z, medium-Z, low-Z or combinations thereof) present in fuel region 102, fuel region 102 may or may not enter runaway burn. If enough high-Z material is present in fuel region 102 as the fuel reaches ignition conditions, the DT will not enter runaway burn. However, for some high-Z, medium-Z, or low-Z mixtures in fuel region 102, the ignition within ICF target 100 can be controlled. There are various advantages for using some high-Z, medium-Z, or low-Z materials and/or mixtures in fuel region 102. One benefit is that the radiation coupling properties within a medium-Z material, such as but not limited to iron, may be more focused and maximize the energy output when igniting an ICF target. It may be advantageous to choose a material which is completely ionized near the ignition temperature of the fuel.

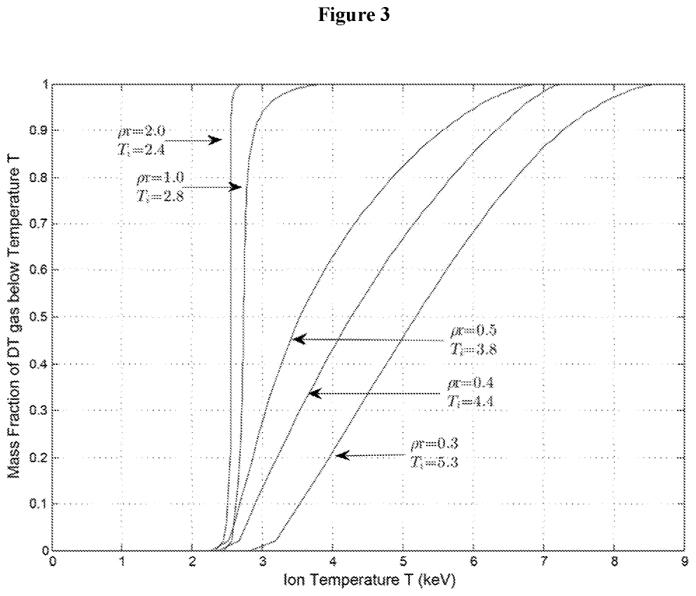

In ICF targets that ignite a DT fuel section having an areal density of less than 1 g/cm² (ρr<1 g/cm²) at ignition, the fuel section tends to have a very non-uniform temperature profile. The temperature profile of the fuel section is seen in FIG. 3, where the mass fraction of DT gas is plotted as a function of temperature. Each of the lines depicted in FIG. 3 represent a different sized target wherein a larger ICF target is represented by the line on the left-hand side with progressively smaller ICF targets to the right. As the areal density (pr) decreases, the temperature profile becomes less uniform. For an ICF target having a ρr=2 g/cm², all of the DT gas has a temperature below 2.7 keV, however for an ICF target having a smaller areal density such as ρr=0.4 g/cm², the temperature profile becomes less uniform, and some of the DT gas has a temperature above 8 keV. This leads to non-equilibrium ignition where the entirety of the fuel does not ignite at the same point in time. Another attribute of non-equilibrium ignition is a non-uniform density profile. In a non-equilibrium ignition target, there are then many complications which arise in predicting the behavior of the target near ignition since non-uniformities in fuel must be coupled to the properties of the high-Z shell surrounding it and vis a versa. By mixing a small amount of medium-Z material (<1% by mass) uniformly through the DT, one can smooth both the temperature and density profiles in the fuel of non-equilibrium ignition targets while still allowing runaway burn but preventing margin parameters such as fall-line from being affected greatly. This reduces the complexity in calculating the stability of the fuel/shell interface immensely.

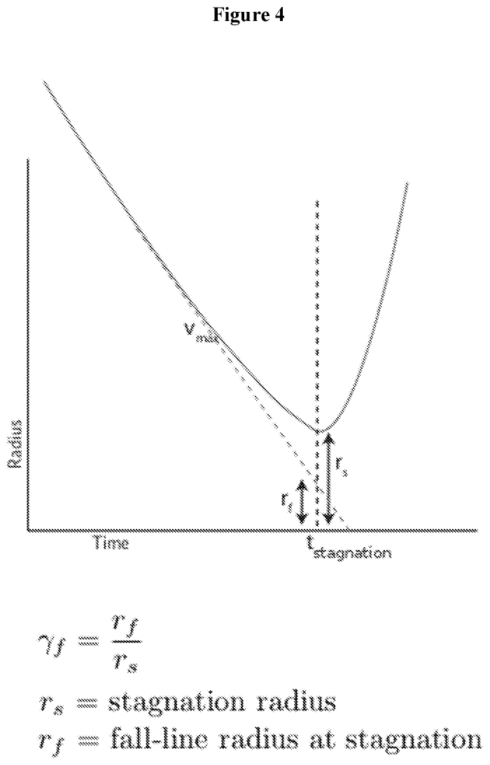

The fall line parameter (γ_{f}) is defined as the radius at which the shell/fuel interface would ignore effects of deceleration over the radius of the interface including the effects of deceleration at the time of stagnation of the fuel/shell interface. In other words, this is fall-line radius at stagnation (r_{f}), divided by the radius of the inner shell at stagnation (rₛ). See FIG. 4.

$${γ}_{f} = \frac{{r}_{f}}{{r}_{s}}$$

The ignition time is defined as a time when mass-averaged fuel temperature is 2.5 keV. The shell convergence (C) is defined as the initial inner shell radius (rᵢ) over the inner shell radius at stagnation (rₛ)

$$C = \frac{{r}_{i}}{{r}_{s}}$$

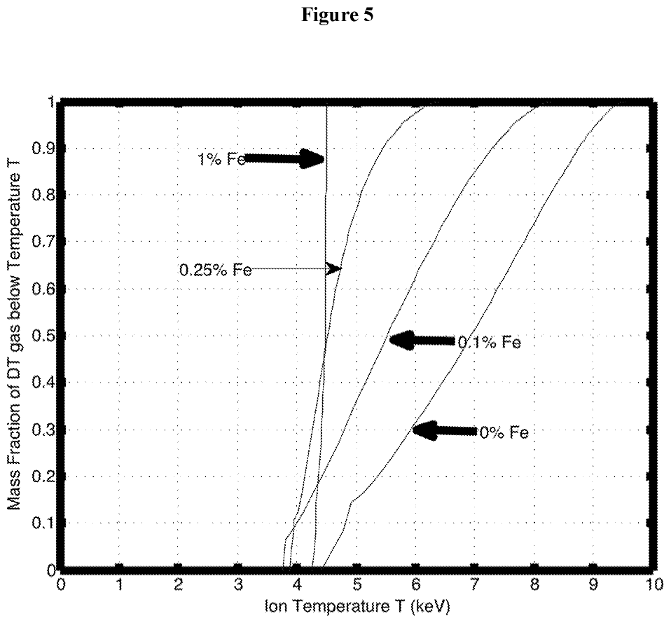

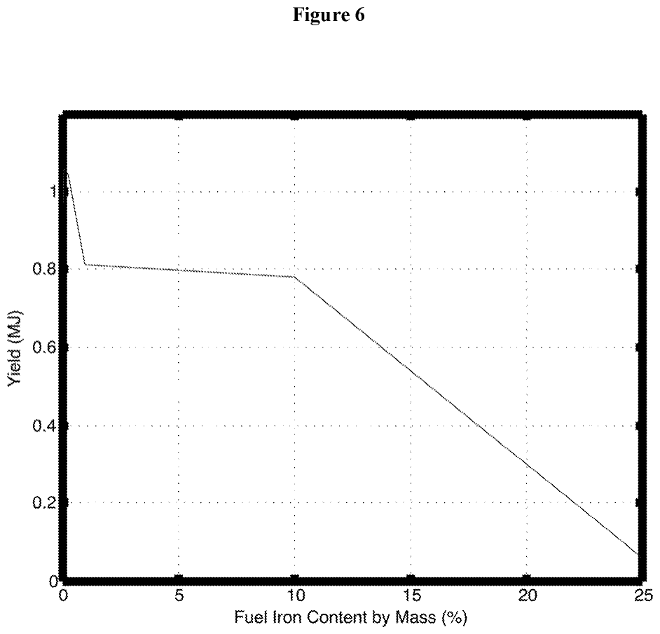

FIG. 5 and Table 1 below, show four cases of the same sized ICF target but with varying degrees of iron mixed into the DT gas (0%, 0.1%, 0.25% and 1.0% by mass of iron). It is clear that the temperature uniformity increases with increasing iron content. However, as the iron content is increased, other effects can be seen. Iron requires more energy than DT to ionize. If the same amount of energy is present in the fuel region, then the greater the iron content, the later in time the target will ignite, as the iron soaks up energy that would have heated the DT. If the target ignites later in time, the high-Z shell has more time to decelerate. This increases the growth of Raleigh-Taylor instabilities on the inside of the shell, causing high-Z material to mix with the DT fuel. If the mix is too severe, the target will fail to ignite. This is also the case for simply increasing the mass of the medium-Z material. For example, as seen in FIG. 6, at a certain point, increasing the iron content in the fuel will begin to decrease the yield of the target. If too much iron is mixed into the fuel, the target will fail to ignite. Again, this will vary slightly by target design. There is therefore, an optimum for a given target design, both for the Z of the mixed material and its content in relation to the DT.

TABLE 1
Parameters due to Varying Degrees
of Iron mixed into the DT (by Mass)

| | 0.0% Fe | 0.1% Fe | 0.25% Fe | 1.0% Fe |
|---|---|---|---|---|
| Convergence | 8.79 | 8.9 | 10.4 | 11.2 |
| Fall-line | 0.03 | 0.06 | 0.08 | −0.39 |
| Yield (MJ) | 0.97 | 1.06 | 1.04 | 0.81 |
| ρr (g/cm²) | 0.33 | 0.34 | 0.44 | 0.59 |

Embodiments of this invention discussed in this application were designed using numerical simulations and hand calculations. This design process necessarily involves making approximations and assumptions. The description of the operation and characteristics of the embodiments presented above is intended to be prophetic, and to aid the reader in understanding the various considerations involving in designing embodiments, and is not to be interpreted as an exact description of how the embodiments will perform, an exact description of how various modifications will change the characteristics of an embodiment, nor as the results of actual real-world experiments.

Additionally, the set of embodiments discussed in this application is intended to be exemplary only, and not an exhaustive list of all possible variants of the invention. Certain features discussed as part of separate embodiments may be combined into a single embodiment. Additionally, embodiments may make use of various features known in the art but not specified explicitly in this application.

Embodiments can be scaled-up and scaled-down in size, and relative proportions of components within embodiments can be changed as well. The range of values of any parameter (e.g. size, thickness, density, mass, etc.) of any component of an embodiment of this invention, or of entire embodiments, spanned by the exemplary embodiments in this application should not be construed as a limit on the maximum or minimum value of that parameter for other embodiments, unless specifically described as such.

1. An Inertial Confinement Fusion (ICF) target, the target comprising:
a central region, wherein said central region comprises a fusion fuel mixture having an areal density of less than approximately 2 g/cm² at ignition; and
a first shell, wherein said first shell is directly surrounding and in direct contact with said central region, and wherein said first shell comprises a material having a Z greater than 48.

2. The target of claim 1, wherein the fusion fuel mixture comprises a material having a Z greater than 48 and is uniformly mixed throughout the fusion fuel mixture.

3. The target of claim 1, wherein the fusion fuel mixture comprises a material having an areal density of less than approximately 1 g/cm² at ignition.

4. The target of claim 3, wherein the fusion fuel mixture comprises a material having less than approximately 1% by mass of a material having a Z between 6 and 47 inclusive, throughout the fusion fuel mixture.

5. The target of claim 4, wherein the fusion fuel mixture comprises a material having an areal density of less than approximately 0.5 g/cm² at ignition.

6. The target of claim 5, wherein the fusion fuel mixture comprises a material having less than approximately 0.5% by mass of a material having a Z between 6 and 47 inclusive, throughout the fusion fuel mixture.

7. The target of claim 6, wherein the material having a Z between 6 and 47 inclusive, is Iron.

8. The target of claim 1, further comprising an outer fuel region and outer shell, wherein said outer fuel region is directly surrounding said first shell and wherein outer shell is directly surrounding said outer fuel region.

9. A method for increasing the stability when igniting an Inertial Confinement Fusion (ICF) target, the method comprising:
providing an ICF target, comprising:
a central region comprising a fusion fuel mixture, and
a first shell directly surrounding and in direct contact with said central region, wherein said first shell comprises a material having a Z greater than 48;
configuring said fusion fuel mixture to have an areal density of less than approximately 2 g/cm² at ignition.

10. The method of claim 9, configuring the fusion fuel mixture to further comprise a material having a Z greater than 48 uniformly mixed throughout the fusion fuel mixture.

11. The method of claim 9, configuring the fusion fuel mixture to further comprise an areal density of less than approximately 1 g/cm² at ignition.

12. The method of claim 11, configuring the fusion fuel mixture to further comprise a material having less than approximately 1% by mass of a material having a Z between 6 and 47 inclusive, throughout the fusion fuel mixture.

13. The method of claim 12, configuring the fusion fuel mixture to further comprise a material having an areal density of less than approximately 0.5 g/cm² at ignition.

14. The method of claim 13, configuring the fusion fuel mixture to further comprise a material having less than approximately 0.5% by mass of a material having a Z between 6 and 47 inclusive, throughout the fusion fuel mixture.

15. The method of claim 14, wherein the material having a Z between 6 and 47 inclusive, is Iron.

16. The method of claim 9, wherein the ICF target further comprises an outer fuel region and outer shell, wherein said outer fuel region is directly surrounding said first shell and wherein outer shell is directly surrounding said outer fuel region.
